(19) United States
(12) Patent Application Publication
(10) Pub. No.: US 2001/0035510 A1
(43) Pub. Date: Nov. 1, 2001

(54) Electromotion ball valve

(76) Inventor: Yong Soo Oh, Seoul (KR)

Correspondence Address: JACOBSON HOLMAN PLLC, 400 SEVENTH STREET N.W., SUITE 600, WASHINGTON, DC, 20004, US

(21) Appl. No.: 09/826,368

(22) Filed: Apr. 5, 2001

(30) Foreign Application Priority Data
Apr. 27, 2000 (KR) 2000-11996
Oct. 4, 2000 (KR) 2000-27631

(51) Int. Cl. F16K 31/02

(52) U.S. Cl. 251/129.03

(57) ABSTRACT

The present invention relates to an electromotion ball valve that rotates by the installation of a geared motor to thereby switch the passage thereof in an automatically operating manner and manipulates a manual lever to thereby switch the passage thereof in a manually operating manner, when the geared motor gets out of order or when the power is off, thereby achieving switching of the ball valve in an convenient manner. The electromotion ball valve has a valve body provided with a passage switching ball and a geared motor connected to the passage switching ball for automatically rotating a ball rotary shaft, which includes: a driving gear provided on a motor shaft of the geared motor; a driven gear provided on the ball rotary shaft and adapted to be engaged with the driving gear; a cam provided on the ball rotary shaft and forming a multistage protrusion on the outer periphery thereof; and a limit switch turned on and off by means of the protrusion and controlling the ball rotary shaft that rotates only in one direction by the geared motor to rotate the ball rotary shaft by 90°, for enabling the ball to switch a passage thereof.

### BACKGROUND OF THE INVENTION

1. Field of the Invention

The present invention relates to an electromotion ball valve and more particularly, to an electromotion ball valve that rotates by the installation of a geared motor to thereby switch the passage thereof in an automatically operating manner as well as manipulates a hand lever to thereby switch the passage thereof in a manually operating manner, thereby achieving the switching of the ball valve in a convenient manner.

2. Description of the Related Art

Generally, most of ball valves, which are provided with a hand-operated lever, are used for switching a hot water pipe or a pipe having a substantially small diameter. Many studies have been made to switch automatically such manual type ball valves, for the purpose of controlling the supply of hot water in a convenient manner. By way of example, an automatic switching device using a solenoid is disclosed in Korea Utility Model Application Laid-open No. 98-20262, where a ball valve is switched in manner that a rotary shaft thereof is connected to the solenoid, with a result that the rectilinear motion of the solenoid is converted into the rotating motion. However, the solenoid has a generally fast rectilinear motion capability, such that the valve can have a serious fatigue by the shock applied from the solenoid. This causes the wearing of the packing of the ball valve and thereby, there is a possibility that water leaks from the ball valve. During the fast rectilinear motion of the solenoid, further, serious noises are generated from the solenoid. In addition, if the solenoid becomes out of order, the ball valve does not operate manually, which makes it inconvenient to use.

On the other hand, a ball valve using a motor is disclosed in Korea Patent No. 198098, where a valve plate rotates by virtue of a plurality of gears connected to the motor. However, the plurality of gears are installed in the interior of the valve, thereby making it difficult to manufacture the valve, and if the gears do not work, they should be separated from the motor for the purpose of repairing the ball valve.

The present inventor has made various studies to solve the above problems and thus, he has proposed a novel electromotion ball valve where a geared motor with a plurality of gears is installed on the top portion of the ball valve, a shaft of the geared motor and a ball rotary shaft of the ball valve are connected by means of a cam and the rotation of the geared motor is controlled by means of a limit switch controlled by the cam, thereby obtaining the following advantages: first, it is constructed in a simple manner; and second, it is convenient to separate the gear motor from the ball valve, such that if there is some trouble with the ball valve, the repairing can be completed within a fast time. The above contents are disclosed in Korea Utility Model Registration No. 196289.

### SUMMARY OF THE INVENTION

Accordingly, the present invention is directed to an improvement of the above registered electromotion ball valve.

It is an object of the present invention to provide an electromotion ball valve that rotates by the installation of a geared motor to thereby switch the passage thereof in an automatically operating manner as well as manipulates a hand lever to thereby switch the passage thereof in a manually operating manner, such that the ball valve can be manually operated in a simple manner, when the geared motor is out of order or when the power is off.

To accomplish this and other objects of the present invention, there is provided an electromotion ball valve having a valve body provided with a passage switching ball and a geared motor connected to the passage switching ball and for automatically rotating a ball rotary shaft, which comprises: a driving gear provided on a motor shaft of the geared motor; a driven gear provided on the ball rotary shaft and adapted to be engaged with the driving gear; a cam provided on the ball rotary shaft and forming a multistage protrusion on the outer periphery thereof; and a limit switch turned on and off by means of the protrusion and controlling the ball rotary shaft that rotates only in one direction by the geared motor to thereby rotate the ball rotary shaft by 90°, for enabling the ball to switch a passage thereof

### BRIEF DESCRIPTION OF THE DRAWINGS

FIG. 1 is a separated perspective view illustrating an electromotion ball valve according to the present invention;

FIGS. 2a and 2b are sectional views of the electromotion ball valve according to the present invention;

FIG. 3 is a sectional view illustrating the operation state of the electromotion ball valve in FIG. 1;

FIG. 4 is a circuit diagram of the electromotion ball valve according to the present invention; and

FIG. 5 is an exemplary view illustrating the use state of the electromotion ball valve.

### DETAILED DESCRIPTION OF THE PREFERRED EMBODIMENT

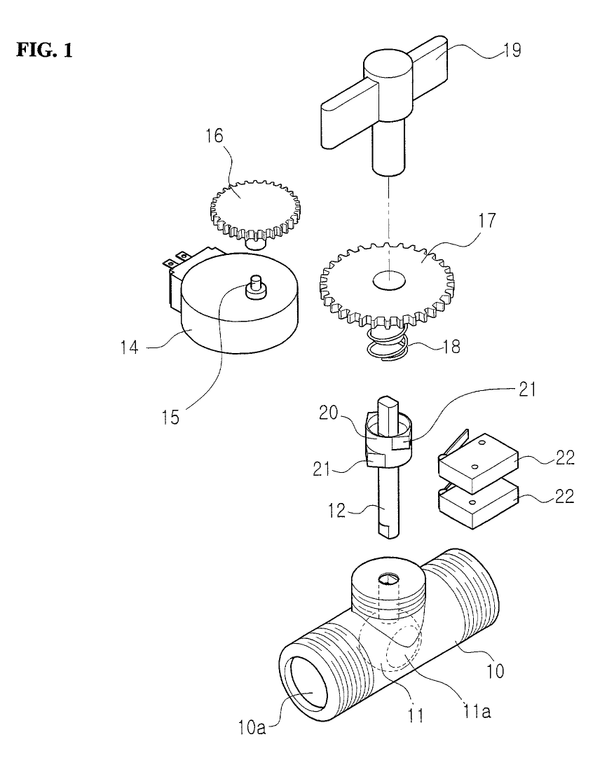

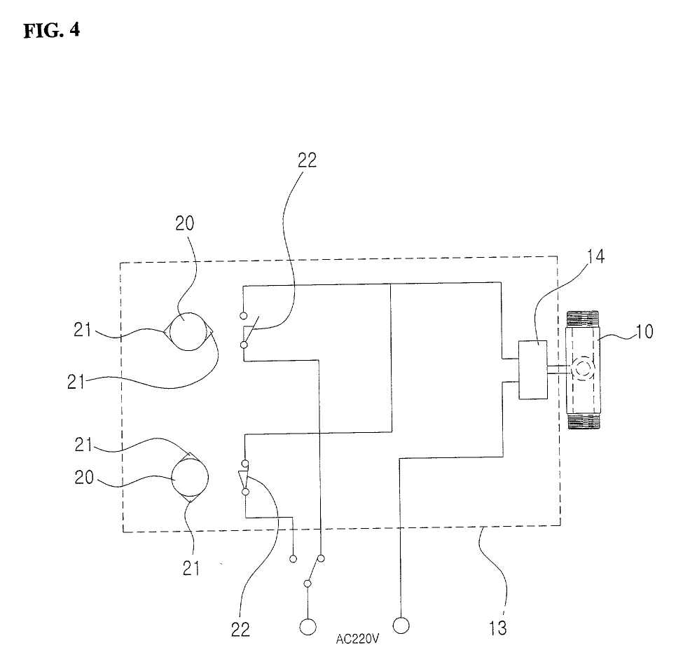

The preferred embodiment of the present invention will be in detail discussed with reference to FIGS. 1 to 5.

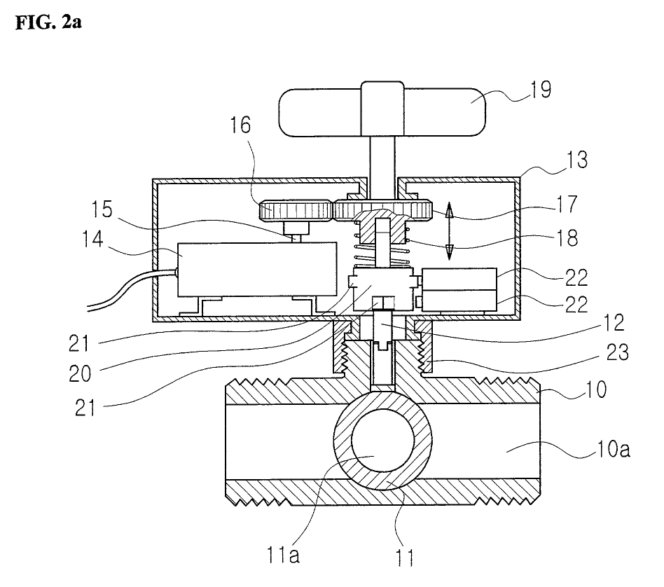

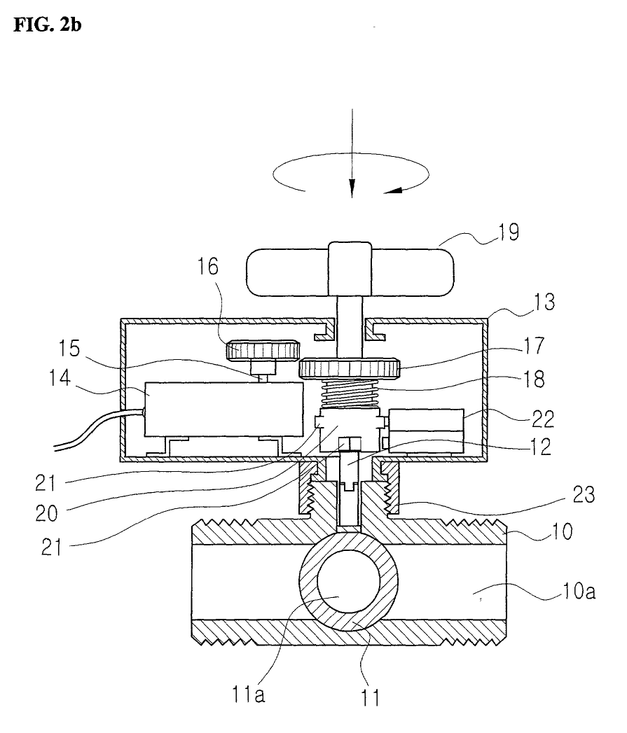

FIG. 1 is a separated perspective view illustrating an electromotion ball valve according to the present invention, and FIG. 2a is a sectional view of the electromotion ball valve according to the present invention. A valve body 10 is provided with a passage 10a and a ball 11 for switching the passage 10a in the interior thereof. The ball 11 is provided with a hole 11a that coincides with the passage 10a and thus, if the hole 11a and the passage 10a coincide with each other, the valve body 10 is opened.

The ball 11 is connected to a ball rotary shaft 12 provided on the top side of the valve body 10, and the ball rotary shaft 12 is provided with a cam 20 that has a multistage projection 21 with intervals of 90°. On the outer periphery of the cam 20 there is provided a limit switch 22 that is turned on and off by the projection 21. Also, a synchronous geared motor 14, which is rotation-controlled by the limit switch 22, is provided on the outer periphery of the cam 20.

The synchronous geared motor 14, the limit switch 22 and the cam 20 are accommodated in a motor case 13 that is provided with the top side of the valve body 10 and is thus assembled to the valve body 10 by means of a nut 23. A driving gear 16 is mounted on a motor shaft 15 of the geared motor 14, and a driven gear 17, which is adapted to be engaged with the driving gear 16, is mounted on the top end of the ball rotary shaft 12.

If the rotating force of the geared motor 14 is transmitted to the driven gear 17 via the driving gear 16, the ball rotary shaft 12 coupled to the driven gear 17 rotates, with a consequence that the ball 11 on the lower end thereof rotates. The rotating force of the geared motor 14 is determined upon the gear ratio of the driving gear 16 and the driven gear 17. Thus, if the gear ratio is high, the rotating force of the geared motor 14 may be improved.

A hand-operated lever 19, which is extruded to the outside of the motor case 13, is mounted on the top side of the driven gear 17. The hand-operated lever 19 and the driven gear 17 are adapted to be ascended along the ball rotary shaft 12. If the hand-operated lever 19 is pressed, the driven gear 17 is moved from the driving gear 16 to the ball 11 and thereafter, if it rotates, the ball 11 rotates in a desired direction. The driven gear 17 is provided with a spring 18 on the lower portion thereof, which enables the driven gear 17 to be forcedly moved to the top side, with a result that the driven gear 17 is engaged with the driving gear 16.

Under the above construction, according to the electromotion ball valve of the present invention, the ball 11 rotates automatically by means of the geared motor 14 or rotates manually by means of the hand-operated lever 19. An operation of the electromotion ball valve according to the present invention will be discussed with reference to FIG. 2b. As shown, if the hole 11 a formed on the ball 11 is disposed in a direction perpendicularly to the passage 10a of the valve body 10, the valve is in a closed state. There are two methods for opening the valve. Firstly, if the valve is to be opened automatically, the power is applied to operate the geared motor 14.

As known, the geared motor 14 with a plurality of gears carries out deceleration with a strong rotating force, even though it is small-sized. If the geared motor 14 rotates, the driving gear 16, which is connected to the motor shaft 15 of the geared motor 14, rotates only in one direction. At this time, the driven gear 17 rotates along with the driving gear 16. As the driven gear 17 rotates, the ball rotary shaft 12 rotates, such that the ball 11 provided in the valve body 10 rotates in the same direction. The cam 20 coupled to the ball rotary shaft 12 rotates during the rotation of the ball 11. If the limit switch 22 is pressed by means of the lower end protrusion 21, the application of power to the geared motor 14 is cut off and the ball 11 stops.

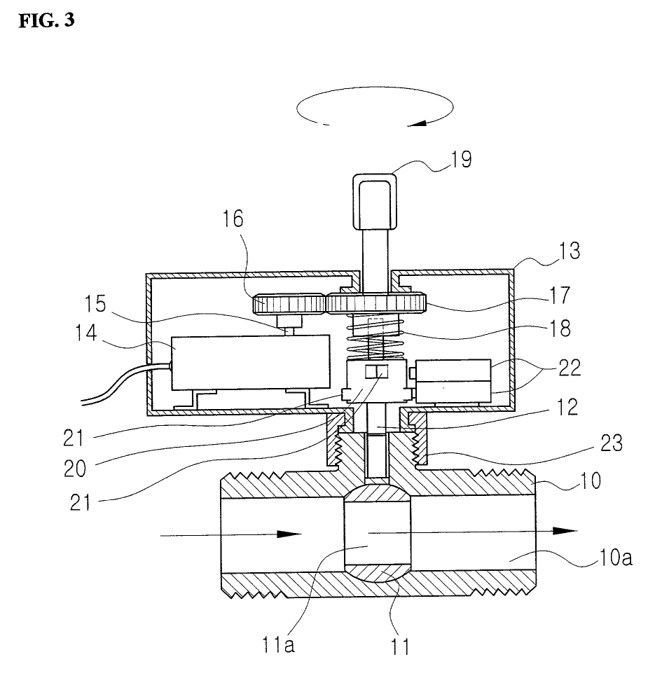

As shown in FIG. 3, if the hole 11a of the ball 11 coincides with the passage 10a to thereby open the passage 10a, the ball 11 rotates by 90° and finally stops by means of the limit switch 22 and the protrusion 21 on the lower end of the cam 20.

While the ball rotary shaft 12 and the driven gear 17 are rotating by the operation of the geared motor 14, the hand-operated lever 19 provided on the outside of the motor case 13 rotates. Therefore, if graduations are marked on the outer peripheral surface of the motor case 13, the opening/closing state of the ball 11 can be checked with the naked eye in accordance with the position of the hand-operated lever 19.

Secondly, the valve can be opened manually. As shown in FIG. 2b, if the hand-operated lever 19 is pressed toward the ball 11, the spring 18 is compressed with a consequence that the driven gear 17 is deviated from the driving gear 16. At this time, if the hand-operated lever 19 rotates in a desired direction, the ball rotary shaft 12 and the ball 11 rotate through the driven gear 17 connected to the hand-operated lever 19, thereby allowing the passage 10a to be opened.

The manual operation is desirable when the geared motor 14 is out of order or when there is a need for a manual control. If pressing the hand-operated lever 19 is released, the spring 18 is restored to its original position and thus, the driven gear 17 is ascended. As a result, the driven gear 17 is engaged with the driving gear 16 to thereby return to its initial state. At this state, the automatic operation of the valve can be achieved with the geared motor 14.

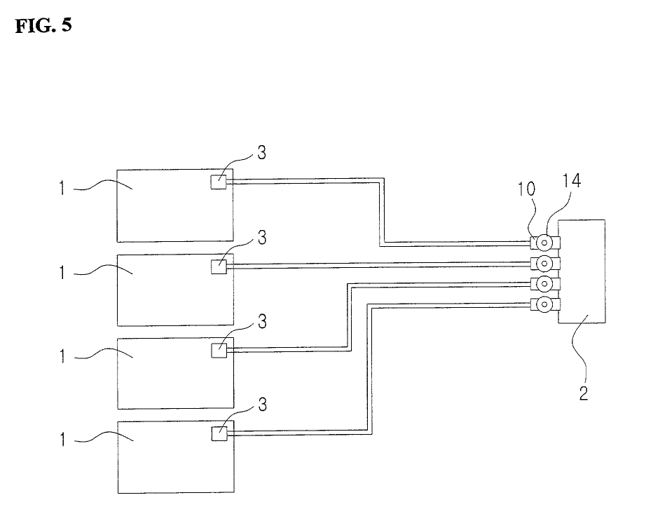

FIG. 5 is an exemplary view illustrating the use state of the electromotion ball valve. The electromotion ball valve according to the present invention can be installed on a distributor 2 for a hot water and heating system. A plurality of valve bodies 10 are installed on the distributor 2 and a plurality of controllers 3 controlling the valve bodies 10 are installed in respective rooms 1.

With the electromotion ball valve having the above construction, the temperature and time desired in the respective rooms 1 can be set by the controllers 3. In this case, the geared motor 14 of the valve body 10 operates to correspond with the desired temperature and time, thereby rotating the ball 11. As a result, the supply of the hot water can be controlled automatically.

Additionally, if the nut 23 is unfastened to separate the motor case 13 from the valve body 10, the ball rotary shaft 12 exposed to the top end of the valve body 10 can be directly rotated by a tool such as a driver. Hence, when the geared motor 14 or the heating controller 3 get out of order, the supply of the hot water can be controlled in a manually operated manner.

As clearly discussed above, an electromotion ball valve according to the present invention is adapted to connect a synchronous geared motor and a valve body by means of driving and driven gears, thereby increasing the rotating force of the geared motor in accordance with the gear ratio of the driving and driven gears, such that the rotation of a ball is achieved in an accurate manner and adapted to rotate the driven gear by means of a hand-operated lever, without operating the geared motor, such that when the geared motor and the ball valve are out of order or when the power is off, the ball can be rotated manually in a convenient manner.

In addition, the synchronous geared motor uses an alternating current, thereby consuming a small amount of power, and the projection of a cam and a ball rotary shaft rotated by the geared motor by a micro-switch are continuously rotated by 90° only in one direction, such that the ball valve can be switched in an accurate manner, without any problem. Further, the valve body is coupled to a motor case by means of a nut in a simple manner, such that it is convenient to separate the valve body from the motor case, upon repairing.

What is claimed is:

1. An electromotion ball valve having a valve body provided with a passage switching ball and a geared motor connected to the passage switching ball for automatically rotating a ball rotary shaft, the valve comprising:
a driving gear provided on a motor shaft of the geared motor, a driven gear provided on the ball rotary shaft and adapted to be engaged with the driving gear;
a cam provided on the ball rotary shaft and forming a multistage protrusion on the outer periphery thereof, and
a limit switch turned on and off by means of the protrusion and controlling the ball rotary shaft that rotates only in one direction by the geared motor to rotate the ball rotary shaft by 90°, for enabling the ball to switch a passage thereof.

2. The electromotion ball valve according to claim 1, wherein the driven gear is provided with a hand-operated lever on the top side thereof, and the ball rotary shaft is provided with a spring supporting the driven gear on the outer periphery thereof, for engaging the driven gear with the driving gear, whereby if the hand-operated lever is pressed, the spring is compressed thus to deviate the driven gear from the driving gear, such that the ball rotary shaft and the ball can be rotated manually by means of the hand-operated lever.
